(19) United States
(12) Patent Application Publication
(10) Pub. No.: US 2013/0230722 A1
(43) Pub. Date: Sep. 5, 2013

(54) CONDUCTIVE THIN FILM AND TRANSPARENT CONDUCTIVE FILM COMPRISING GRAPHENE

(71) Applicants: Takeshi Fujii, Hino-city (JP); Yasushi Ogimoto, Higashiyamato-city (JP)

(72) Inventors: Takeshi Fujii, Hino-city (JP); Yasushi Ogimoto, Higashiyamato-city (JP)

(73) Assignee: FUJI ELECTRIC CO., LTD., Kawasaki-shi (JP)

(21) Appl. No.: 13/884,917

(22) PCT Filed: Nov. 9, 2011
(86) PCT No.: PCT/JP2011/075814

§ 371 Date: May 10, 2013

(30) Foreign Application Priority Data
Nov. 24, 2010 (JP) 2010-261336

(51) Int. Cl. H01B 5/00

(52) U.S. Cl. CPC H01B 5/00
USPC 428/408

(57) ABSTRACT

A conductive thin film including graphene and having improved conductivity is disclosed. The conductive thin film is composed of a superlattice structure that includes a first and second graphene films formed of respective sheets of carbon atoms that each have at least one atomic layer; and an intercalation film sandwiched between the first and second graphene films. The superlattice structure may have a plurality of stacking units that are stacked and that are each formed of one graphene film and one intercalation film; and the first and second graphene films may have graphene films belonging to two mutually adjacent stacking units from among the plurality of stacking units. The conductive thin film may be transparent and, when the superlattice structure has a plurality of stacking units, a sum total of atomic layers of the sheets of carbon atoms for all the stacking units is ten or fewer.

### BACKGROUND OF THE INVENTION

1. Field of the Invention

The present invention relates to a conductive thin film and a transparent conductive film that comprise graphene. More particularly, the present invention relates to a conductive thin film and a transparent conductive film that have a superlattice structure that comprises graphene.

2. Background of the Related Art

Much interest has been raised, in the field of condensed-matter physics, by graphene, namely a substance having a two-dimensional crystal structure in which multiple carbon atoms are arranged planarly. So-called monolayer graphene, i.e. graphene comprising a single atomic layer of carbon atoms, is being actually produced in accordance with a method that involves mechanically stripping graphite, which has a structure wherein atomic layers of carbon atoms are superposed on each other, see Non-Patent Document 1, K. S. Novoselov et al., Science 306 (2004) 666 and Non-Patent Document 2, K. S. Novoselov et al., Proc. Natl. Acad. Sci. U.S.A. No. 102, 10451 (2005). One of the reasons underlying the interest in graphene is the peculiar quantum conductance that graphene displays. That quantum conductance derives from the two-dimensionality of the structure of graphene, i.e. from the fact that graphene exhibits a structure in which carbon atoms are planarly bonded to each other by sp² bonds. A half-integer Hall effect, which is a quantum conductance phenomenon, is actually observed in graphene.

From the viewpoint of industrial applicability, monolayer graphene in particular has drawn attention, by virtue of its high mobility, among graphene varieties. Specifically, the mobility of monolayer graphene reaches values as high as 15000 cm²/Vs, higher by an order of magnitude or more than that of single-crystal silicon. Focusing on this feature, various applications have been proposed for graphene. Such varied applications include, for instance, high-performance transistors that surpass the performance of silicon-made transistors, gas sensors so sensitive as to being capable of detecting single molecules, as well as spin injection devices. Conductive thin films and transparent conductive films, in particular, have become the object of active research and development, given the industrial usefulness of such films.

Sheet resistance is a major indicator of electric performance in conductive thin films. The value of sheet resistance is ordinarily inversely proportional to the thickness of a thin film and to the conductivity of the material of the thin film. Accordingly, sheet resistance can be reduced in ordinary conductive thin films by increasing the thickness of the film. Conductivity is proportional to the mobility of conduction carriers (hereafter simply referred to as “mobility”). In turn, mobility depends on the crystalline state, i.e. on the film quality, of the formed conductive thin film. Accordingly, the sheet resistance of the conductive thin film can be reduced by improving the film quality of the conductive thin film. Non-Patent Document 3, Xuesong et al., Nano Lett. No. 9 4359-4362 (2009), discloses the feature of forming uniformly graphene of good quality on a Cu foil, by CVD.

Optical transmittance is also an important indicator, besides sheet resistance relating to conductivity, in cases where graphene is used in a transparent conductive film.

The inventors of the present application have studied the electrical conductivity of thin films obtained by growing sheets of carbon atoms that are included in graphene films, by atomic layer units, i.e. in a layer-by-layer fashion. In those studies, the inventors have noticed that a method that involves increasing film thickness to reduce thereby sheet resistance is difficult to apply, for reasons of principle, to atomic layers of carbon atoms. In the case of graphene films, specifically, sheet resistance does not vary in inverse proportion to an increase in film thickness, even when atomic layers are grown through stacking of a plurality of atomic layers of carbon atoms in order to increase film thickness. Even if film thickness is increased through stacking of a plurality of atomic layers of carbon atoms, the mobility in each atomic layer of carbon atoms decreases, and high mobility such as that in the case of monolayer graphene fails to be achieved. Accordingly, a method that involves increasing film thickness in order to reduce electric resistance in a thin film is not found to be necessarily effective in conductive thin films or transparent conductive films where graphene is used as a conductive material,

Optical transmittance must also be considered in those instances where the conductive thin film that relies on sheets of carbon atoms is used in a transparent conductive film. A tradeoff between sheet resistance and transmittance arises ordinarily, on account of film thickness, in a transparent conductive film. That is because absorption increases, and optical transmittance decreases, when the film is made thicker in order to reduce sheet resistance. Transparent conductive films that rely on atomic layers of carbon atoms cannot escape this tradeoff, and thus optical transmittance accordingly drops in response to increases in film thickness of the transparent conductive film derived from increases in the number of the atomic layers included in the sheets of carbon atoms. In particular, Non-Patent Document 4, R. R. Nair et al., Science No. 320, 1308 (2008), discloses a feature wherein optical absorption by sheets of carbon atoms is 2.3%, expressed as the absorptance of light that traverses, in the thickness direction, one atomic layer of carbon atoms. On the assumption that the value of absorptance per one atomic layer is 2.3%, and the transmittance of a transparent conductive film as required in practice is 80%, it is estimated that the number of atomic layers included in sheets of carbon atoms can correspond, at most, to a stack of only about ten atomic layers. In transparent conductive films as well, drops in mobility occur in graphene films in which there are formed sheets of carbon atoms comprising a plurality of atomic layers, as described above. Therefore, it is difficult to maintain transmittance while reducing sheet resistance in the sheets of carbon atoms.

The purpose of the present invention is o tackle these issues. Specifically, the present invention contributes to the production of a high-performance conductive thin film, or transparent conductive film, by providing a film structure such that high mobility, as observed in monolayer graphene, is preserved as far as possible, even when using sheets of carbon atoms of a plurality of atomic layers.

### SUMMARY OF THE INVENTION

In order to solve the above-described problems, the inventors of the present application focused on the mechanism of electrical conductivity in sheets of carbon atoms. A graphene film formed of sheets of carbon atoms is a film-like object of simple carbon formed of a sheet of carbon atoms the number of atomic layers of which is one or more. Graphene films include not only monolayer graphene, but also sheets of carbon atoms of a single atomic layer or of a plurality of atomic layers, such as bilayer graphene, in which the number of atomic layers included in the sheet of carbon atoms is two, and trilayer graphene, in which the number of atomic layers is three. In the case of monolayer graphene, the band structure of electrons in the plane where the sheet of carbon atoms is contained takes on a state referred to as Dirac cone that yields a linear dispersion relation. This peculiar band structure gives rise to the above-described high mobility. When atomic layers of carbon atoms are stacked adjacent to each other, by contrast, the band structure of electrons changes from the above-described peculiar band structure to that of a metalloid as the number of atomic layers in the sheet of carbon atoms increases. The inventors speculated that this change in band structure might underlie the drop in mobility in cases of increased number of atomic layers included in the sheet of carbon atoms.

The inventors looked further into that idea, and found that it is possible to suppress the changeover to a metalloid band structure. In more detailed terms, the changeover to a metalloid band structure is caused by hybridization in the sheets of carbon atoms, whereby π-electron orbitals belonging to carbon atoms in respective atomic layers hybridize with π-electron orbitals of carbon atoms in adjacent atomic layers. Therefore, π-electron hybridization should conceivably be rendered unlikelier if it were possible to weaken the interactions between π-electrons belonging to the individual atomic layers of the carbon atoms, in carbon-atom atomic layers formed adjacent to each other. Changes in the band structure that accompany the superposition of atomic layers of carbon atoms would thus be suppressed, and the mobility in each atomic layer of carbon atoms would approach the mobility of monolayer graphene. The present invention was arrived at by developing that idea.

In a first aspect of the present invention, specifically, there is provided a conductive thin film comprising a superlattice structure that includes a first graphene film formed of a sheet of carbon atoms having one or more atomic layers; a second graphene film formed of a sheet of carbon atoms having one or more atomic layers; and an intercalation film sandwiched between the first and second graphene films.

The superlattice structure may have a plurality of stacking units that are stacked and that are each formed of one graphene film and one intercalation film; and the first and second graphene films may be graphene films belonging to two mutually adjacent stacking units from among the plurality of stacking units.

The intercalation film may be made of an insulator material. The intercalation film may be made of a metallic material.

The intercalation film may comprise a first unit intercalation film and a second unit intercalation film having mutually dissimilar compositions. A combination of the first unit intercalation film and the second unit intercalation film may be one of (a) a combination of an insulator material and a metallic material, respectively, and (b) a combination of a metallic material and an insulator material, respectively. The superlattice structure may have a plurality of stacking units that are stacked and that are each formed of one graphene film, one first unit intercalation film and one second unit intercalation film; and the first and second graphene films may be graphene films belonging to two mutually adjacent stacking units from among the plurality of stacking units.

The intercalation film may comprise a first unit intercalation film made of an insulator material, a second unit intercalation film made of a metallic material, and a third unit intercalation film made of an insulator material. The superlattice structure may have a plurality of stacking units that are stacked and that are each formed of one graphene film, one first unit intercalation film, one second unit intercalation film, and one third intercalation film; and the first and second graphene films may be graphene films belonging to two mutually adjacent stacking units from among the plurality of stacking units.

The intercalation film has a plane and includes an atomic layer having a crystal lattice that has three-fold symmetry or six-fold symmetry in the plane of the intercalation film.

The first and second graphene films may be made of respective sheets of carbon atoms that each have from one to five atomic layers, respectively.

The intercalation film may be made of from one to ten atomic layers.

In each of the stacking units, the intercalation film may be made of three atomic layers, and the first and second graphene films may be made of respective sheets of carbon atoms that each have one atomic layer.

In a second aspect of the present invention, a transparent conductive film is provided. Specifically, there is provided a transparent conductive film comprising a superlattice structure that includes a first graphene film formed of a sheet of carbon atoms having one or more atomic layers; a second graphene film formed of a sheet of carbon atoms having one or more atomic layers; and an intercalation film sandwiched between the first and second graphene films.

The superlattice structure may have a plurality of stacking units that are stacked and that are each formed of one graphene film and one intercalation film; the first and second graphene films are graphene films belonging to two mutually adjacent stacking units from among the plurality of stacking units; and the graphene films are made of respective sheets of carbon atoms that each have at least one atomic layer and a sum total of atomic layers of the sheets of carbon atoms for all the stacking units is ten or fewer.

Herein, the superlattice structure denotes a layer structure resulting from superposition of element thin films comprising atoms or molecules. An example of the abovementioned superlattice structure is any layer structure of a combined stacking of elements, as thin-film elements, having materials of dissimilar compositions that are selected to be distinct from each other. As the thin-film element there can be selected, for instance, a sheet of one or more atomic layers comprising a crystal of carbon atoms, a sheet of one or more atomic layers of metal atoms, and a sheet of one or more atomic layers of a single element, molecular crystal of a compound, ionic crystal and covalent crystal, that make up an insulator. A further example of the abovementioned superlattice structure is a layer structure in which there are alternately formed, in the thickness direction, a film (graphene film) being a sheet of carbon atoms comprising carbon atoms in one or more atomic layers, and a film formed of a sheet of one or more atomic layers of a substance, which constitutes an intercalation film.

Herein, graphene denotes a composition of elementary carbon being a sheet of carbon atoms of any number of atomic layers equal to or greater than one. To clearly illustrate the features of the present invention, however, the simple term “graphene” will not be used, except for several clear instances such as monolayer, bilayer and trilayer graphene, and more definite terms will be used instead. Firstly, the notation “a sheet of carbon atoms, sheets of carbon atoms” will be used to particularly denote a crystal structure made up of a planar arrangement of carbon atoms. In order to indicate that a sheet comprising carbon atoms in any number of atomic layers equal to or greater than one is, in particular, a thin film of arbitrary thickness and comprising elementary carbon, the term “graphene film” will be used to denote that thin film as a whole. Therefore, any mention of a graphene film in the present application encompasses not only so-called monolayer graphene, but also a structure of a sheet of carbon atoms of any number of atomic layers, typically bilayer graphene, trilayer graphene and the like. The graphene film in the present application is formed in such a way so as to preclude, as much as possible, the presence of any substance other than sheets of carbon atoms. The sheets of carbon atoms have generally a two-dimensional planar expanse, but the bounds of that expanse are not defined.

In the above aspects of the present invention, an intercalation film is positioned so as to be sandwiched between the first and second graphene films in the superlattice structure. By resorting to this superlattice structure, it becomes possible to weaken electron interactions, such as those of π-electrons, between the atomic layers of carbon atoms belonging to the first graphene film and the atomic layers of carbon atoms belonging to the second graphene film, as compared with an instance where no intercalation film is disposed. In the conductive thin film in the above aspects of the present invention, therefore, the mobility exhibited by the individual atomic layers of carbon atoms can be maintained high, and high conductivity can be realized, as compared with the case of a conductive thin film comprising a graphene film that is configured in the form of a direct superposition of entire atomic layers of carbon atoms.

In the above-described s of the present invention, preferably, the superIattice structure is a superlattice structure in which there are stacked a plurality of stacking units each formed of a (graphene film/the intercalation film), and the first and second graphene films are graphene films belonging to two mutually adjacent stacking units from among the plurality of stacking units that have been stacked. A stacking unit is herein a combination of thin films, which constitute respective elements, included in the superIattice structure, and constitutes a unit upon formation of the superlattice structure through stacking of a plurality of stacking units. In the present application, the order of the thin films that constitute the elements that make up the stacking unit, as well as the composition or substances in the thin films, is explicitly notated within brackets.

The transparent conductive film in the present application denotes a thin film, from among conductive thin films, that exhibits optical transparency. A film exhibiting optical transparency has herein optical transmittance as required for given applications. Examples of prerequisites for optical transmittance include, for instance, the requirement of exhibiting a transmittance equal to or higher than a given value, at the band of the intended application, for instance, ultraviolet, visible, infrared or the like, or at a wavelength region or frequency region specified in the form of upper and lower limits. It is indifferent whether the transparent conductive film of the present application has or not the ability of upsetting the propagation direction of light, i.e. exhibits or not scattering and/or haze.

In the various aspects of the present invention it becomes possible to incorporate, in a conductive thin film, sheets of carbon atoms having a plurality of atomic layers while preserving, as far as possible, the high mobility exhibited by sheets of carbon atoms of one atomic layer in graphene. Accordingly, a conductive thin film as well as a transparent conductive film having low sheet resistance can be provided in the various aspects of the present invention.

### BRIEF DESCRIPTION OF THE DRAWING

FIG. 1 is a schematic cross-sectional diagram illustrating a configuration example of a conductive thin film (conductive thin film 1000) in an embodiment of the present invention;

FIG. 2 is a set of schematic cross-sectional diagrams illustrating a configuration example of conductive thin films (conductive thin films 1100 and 1200) in an embodiment of the present invention;

FIG. 3 is a cross-sectional schematic diagram illustrating a configuration example of a conductive thin film (conductive thin film 1300) in an embodiment of the present invention, being a conceptual diagram of a stack of a graphene film, a first unit intercalation film, a second unit intercalation film and a first unit intercalation film;

FIG. 4 is a cross-sectional schematic diagram illustrating a configuration example of a conductive thin film (conductive thin film 1400) in an embodiment of the present invention;

FIG. 5 is a graph of measurement results of electric characteristics in samples of Example 1 of a conductive thin film produced in an embodiment of the present invention;

FIG. 6 is a graph of measurement results of conductivity and optical transmittance in samples of Example 2 of a conductive thin film produced in an embodiment of the present invention; and

FIG. 7 is a graph of measurement results of conductivity and optical transmittance in samples of Example 3 of a conductive thin film produced in an embodiment of the present invention.

### DETAILED DESCRIPTION OF THE INVENTION

Embodiments of the present invention are explained in detail below. Unless particularly stated otherwise, common portions or elements share the same reference numerals across drawings. The elements in the various embodiments are not necessarily depicted with the scale thereof preserved across the drawings. In the present application, the term “comprising” indicates that impurities may be present in a given composition, in an amount so as not to depart from the scope of the invention of the present application.

### First Embodiment

An explanation follows next, in a first embodiment of the present invention, on a mode for carrying out the invention that involves forming a conductive thin film or a transparent conductive film that comprises a graphene film.

The conductive thin film of the present embodiment is provided with a superlattice structure that comprises a first graphene film formed of a sheet of carbon atoms of one or more atomic layers, a second graphene film formed of a sheet of carbon atoms of one or more atomic layers, and an intercalation film that is sandwiched between the first and second graphene films. In the simplest case, the superlattice structure of the conductive thin film of the present embodiment involves a configuration wherein, for instance, a first graphene film is formed on one face of a substrate that is lattice-matched to a sheet of carbon atoms, an intercalation film is formed next, and a second graphene film is further formed thereon. Such a superlattice structure needs not necessarily have a periodic configuration.

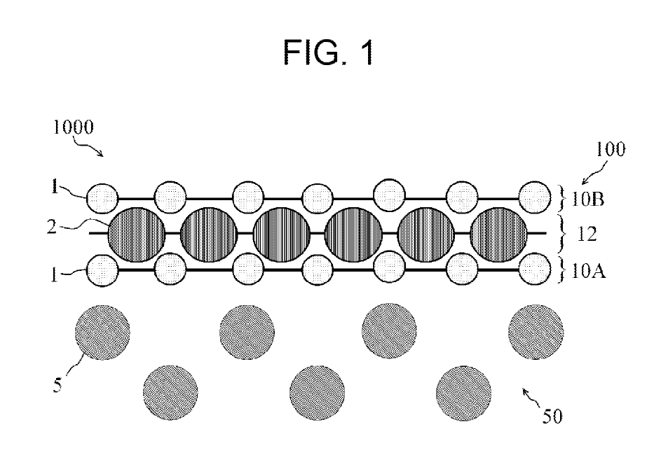

FIG. 1 is a schematic cross-sectional diagram illustrating a configuration example (conductive thin film 1000) of the conductive thin film of the present embodiment, with the superlattice structure of the conductive thin film of the present embodiment being depicted by a minimal element thereof. As illustrated in FIG. 1, the conductive thin film 1000 of the present embodiment comprises a superlattice structure 100. The superlattice structure 100 comprises a first graphene film 10A formed of a sheet of carbon atoms of one or more atomic layers, a second graphene film 10B formed of a sheet of carbon atoms of one or more atomic layers, and an intercalation film 12. The conductive thin film 1000 comprises typically the superlattice structure 100 that is formed so as to be lattice-matched to the crystal lattice of atoms or molecules 5 that make up the substrate 50. In the superlattice structure 100, the first and second graphene films 10A and 10B are sheets of carbon atoms 1 of one atomic layer. The sheets of carbon atoms 1 are depicted in FIG. 1 in the form of a plurality of circles connected by segments. The array of circles represents a virtual cutout of carbon atoms 1 that are planarly arrayed. The segments that connect the circles represent the chemical bonds between carbon atoms 1 that belong to one same atomic layer. The same applies to the intercalation film 12, where the atoms or molecules 2 that make up the intercalation film 12 are represented by circles, and the chemical bonds within the sheet of atoms are represented by segments. This is true also of the substrate 50. Segments, however, have been omitted in the substrate 50. Herein, the term atoms or molecules 2 of the intercalation film 12 does not imply that the atoms that make up the intercalation film 12 are of the same type. For the sake of a clearer explanation of the invention, the drawings in the present application explicitly depict the atoms of the respective sheets of atoms. In the drawings of the present application, however, the positions in the left-right direction in the various drawings of the present application, and the mutual positions of the atoms represented as positions perpendicular to the paper surface in the figures, are not necessarily represented accurately, for a single sheet of atoms or across respective sheets of atoms.

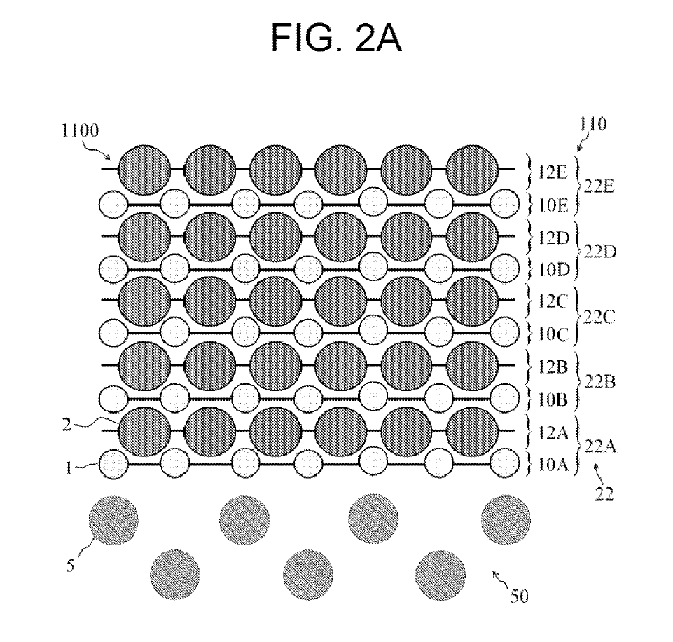

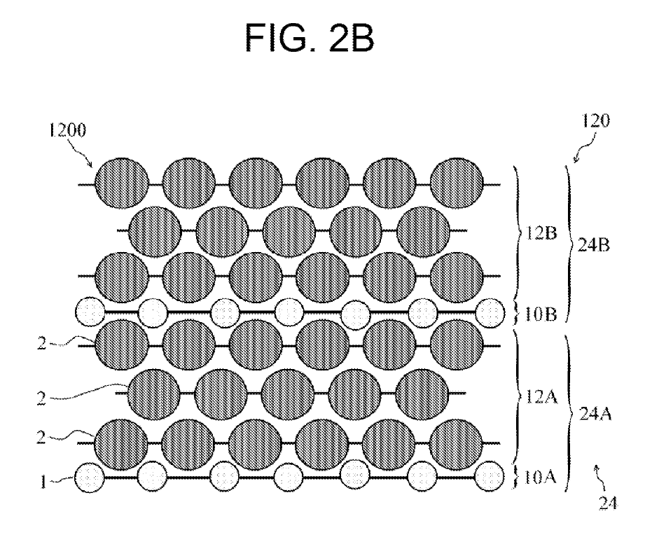

The superlattice structure of the conductive thin film of the present embodiment results from stacking a plurality of stacking units each formed of a (graphene film/intercalation film). FIG. 2 is a set of schematic cross-sectional diagrams illustrating conductive thin films 1100 and 1200, as configuration examples of the conductive thin film of the present embodiment. The conductive thin film 1100 illustrated in FIG. 2(a) comprises a superlattice structure 110. The superlattice structure 110 is provided with stacking units 22 each of which comprises an intercalation film 12 and a graphene film 10 formed of a sheet of carbon atoms 1 of one or more atomic layers. Hereafter, the various stacking units will be denoted by respective letters, such as stacking unit 22A and so forth, in cases where the individual stacking units are specified or distinguished. Letters will not be explicitly added; i.e. stacking unit 22 and so forth, if the stacking units are referred to collectively. The same applies to the various elements included in the respective stacking units. The intercalation film 12 comprises a sheet of atoms or molecules 2. The superlattice structure 110 results from stacking a plurality of the stacking units 22. Typically, as illustrated in FIG. 2(a), a stacking unit 22B is adjacently formed on a face of stacking unit 22A, without any other layer interposed in between. The stacking units 22C, 22D, 22E are likewise sequentially formed adjacent to each other. The conductive thin film 1100 is typically formed so as to be lattice-matched to the crystal structure of the atoms or molecules 5 that make up the substrate 50. FIG. 2 illustrates a structure wherein the stacking units 22 in the conductive thin film 1100 are formed out of just five units, namely stacking units 22A to 22E, but the number of units of the stacking units 22 is not particularly limited thereto.

As a comparison between FIG. 1 and FIG. 2(a) makes clear, the two graphene films 10A and 10B that belong to the stacking units 22A and 22B in FIG. 2(a) stand in the same positional relationship as that of the first graphene film 10A and the second graphene film 10B in FIG. 1, also as regards the feature of being positioned sandwiching the intercalation film 12A that belongs to the stacking unit 22A. Hereafter, the first graphene film 10A and the second graphene film 10B of FIG. 1, where no definite stacking unit is indicated, will be regarded as part of the collective denomination “graphene film 10” when no distinction among the graphene films is needed.

The superlattice structure 110 of the conductive thin film 1100 of FIG. 2(a) is produced through sequential formation of the films of the elements that make up each stacking unit 22, from the side of the substrate 50. For instance, the stacking unit 22A is formed through formation of the graphene film 10A followed by formation of the intercalation film 12A, and the stacking unit 22B is formed in the same way; this process is repeated to produce thereby the superlattice structure 110.

In the conductive thin films 1000 and 1100 in FIG. 1 and FIG. 2(a), the various graphene films 10 are depicted as sheets of carbon atoms 1 of a single atomic layer. Unless specifically stated otherwise, however, the various graphene films 10 included in the conductive thin films 1000 and 1100 can be graphene films formed of a sheet of carbon atoms that comprises a plurality of atomic layers. The graphene film 10 is typically produced in such a way so as to avoid, as much as possible, the presence of substances other than sheets of carbon atoms.

The graphene film 10 is formed by epitaxial growth on a face of the substrate 50, which is for instance a single-crystal substrate. The substrate 50 for epitaxial growth has, for instance, a crystal structure of three-fold symmetry or six-fold symmetry. Examples of single-crystal substrates of crystal structure having three-fold symmetry include, for instance, a Fe(111) plane, a Ni(111) plane, a Cu(111) plane, an Ir(111) plane, a Pd(111) plane, a Pt(111) plane and the like. Examples of single-crystal substrates of crystal structure having six-fold symmetry include, for instance, a Co(0001) plane, a Ru(0001) plane, an Al₂O₃(0001) plane (sapphire) and the like. The type of substrate will be specified using a notation that combines chemical composition and plane indices, for instance “Ni(111) plane”. Typically, the conductive thin film 1000 or 1100 comprising the graphene film 10 that is grown on a given face of the substrate 50 is used by being supported, as-is, on the substrate 50. In another mode of use, the conductive thin film 1000 or 1100 that is grown on a given face of the substrate 50 is stripped off the substrate 50, in accordance with some method, at an appropriate timing. The stripped conductive thin film 1000 or 1100 can be used as a free standing film, or as a film that is supported on another object, in accordance with the intended use. The other object that can be used is not particularly limited, and examples thereof include, for instance, a substrate other than a substrate used for growth, or some electronic device. The conductive thin film 1000 or 1100 stripped off the substrate 50 can be used, as the case may require, in a various types of processes, for instance transfer to another object, coating after dispersion in the form of a micro-powder, or winding onto a roll after formation on a polymer supporting film.

A sheet of carbon atoms 1 exhibits a strong two-dimensional character, and binding of the sheet to the substrate is weaker than in ordinary crystals. By devising an appropriate scheme, therefore, the graphene film 10 can be formed through epitaxial growth on a substrate other than a typical substrate for growth. For instance, the graphene film 10 can be grown by using a substrate exhibiting neither three-fold symmetry nor six-fold symmetry, but for instance a substrate exhibiting four-fold symmetry, or a substrate having a lattice constant dissimilar from to that of graphene, or a substrate that cannot be completely regarded as a single-crystal substrate. Therefore, the abovementioned lattice matching denotes ordinarily a state of crystal lattice matching that enables, at least partially, epitaxial growth between the substrate 50 and the graphene film 10. Lattice matching between the substrate and the film does not entail herein restricting the degree of matching of crystal lattice symmetry and of lattice constants to be so high as to completely rule out the occurrence of lattice strain and of film stress that accompanies lattice strain.

The epitaxial growth method of the graphene film 10 that is used in the present embodiment is typically chemical vapor deposition (CVD) or physical vapor deposition (PVD). In a case where CVD is resorted to, a hydrocarbon gas is brought to a high-temperature heated state in a gas atmosphere at atmospheric pressure or in a vacuum vessel that has been evacuated to ultra-high vacuum, and the gas is blown onto the face of the substrate 50 that is lattice-matched to the sheet of carbon atoms. In this treatment, molecules of the hydrocarbon gas such as methane undergo cracking and release radicals. The radicals move, in other words, migrate along the surface of the substrate 50 onto which the gas is blown, for instance, along the surface of a Ni(111) plane. Upon reaching an atomic step end of the atoms that make up the substrate 50, the radicals become deposited on the end section of the atomic step, to yield a sheet of carbon atoms 1 that make up the graphene film 10. Ongoing formation of the graphene film 10 proceeds thus as sheets of carbon atoms 1 are grown, in a layer-by-layer fashion, on a face of the substrate 50. The hydrocarbon gas that constitutes the starting gas in a case where CVD is resorted to is not particularly limited. Representative starting gases include, for instance, a starting gas of a saturated or unsaturated hydrocarbon, for instance an alkane such as methane, an alkene such as ethylene or an alkyne as acetylene. Other than the above, there can be used a starting gas of a substance having any chemical structure, for instance linear, branched or cyclic.

A specific PVD method that can be used for growing the graphene film 10 may be, for instance, MBE (molecular beam epitaxy) or PLD (pulse laser deposition). In order to grow graphene by MBE, graphite, which constitutes the source of the carbon atoms 1, is heated firstly at about 2000° C. in a vacuum vessel evacuated to ultra-high vacuum. A molecular beam of atomic carbon is formed as a result. When the molecular beam is supplied towards one of the faces of the heated substrate 50, atomic carbon that reaches the substrate 50 becomes overlaid, in a layer-by-layer fashion, on a face of the substrate 50, as a result of which there is formed the graphene film 10 formed of a sheet of carbon atoms 1. A high-quality graphene film 10 formed of a sheet of carbon atoms 1 can thus be formed if MBE is resorted to.

In a case where graphene film 10 is formed by PLD, for instance a KrF excimer laser (wavelength 248 nm), of adjusted irradiation intensity i.e. power density, is irradiated onto graphite in a vacuum vessel that has been evacuated to ultra-high vacuum of about 1×10⁻⁹ Torr (1.33×10⁻⁷ Pa). The carbon that vaporizes instantly through laser ablation forms an atom-like molecular beam. This carbon molecular beam is supplied to the heated lattice-matched substrate 50, to elicit thereby layer-by-layer growth. A high-quality graphene film 10 comprising a sheet of carbon atoms 1 can thus be formed by PLD as well.

When either a CVD or PVD method is resorted to, the number of atomic layers in the sheets of carbon atoms that are formed as the graphene film 10 is controlled in both instances by adjusting the formation time and the various process conditions. The film quality of the graphene film 10, i.e. the uniformity of the crystal structure in the sheets of carbon atoms 1, is controlled by appropriately adjusting the parameters for forming the graphene film, such as the temperature of the substrate 50 and the process temperature.

Herein, the graphene film 10 in the conductive thin films 1000 and 1100 illustrated in FIG. 1 and FIG. 2(a) can be not to have a number of atomic layers of two or more (not shown). In the present embodiment, the number of atomic layers in the sheets of carbon atoms 1 that make up the graphene film 10 ranges preferably from one to five. More preferably, the sheets of carbon atoms in respective graphene films 10 comprise each only one atomic layer. In a case where the graphene film 10 comprises a sheet of carbon atoms of six or more atomic layers, the atomic layers of carbon atoms are disposed so as to be close to each other in the interior the graphene film 10. The electron band structure in the graphene film 10 becomes a metalloid band structure in this case. By contrast, if the number of atomic layers in a sheet of carbon atoms 1 in the graphene film 10 is set to range from one to five, and particularly preferably is set to one, then the mobility in the graphene film 10 takes on a value close to the high mobility exhibited by a sheet of carbon atoms that comprises a single atomic layer (monolayer graphene).

The intercalation film 12 is a film that has a sheet of atoms or molecules 2 of one or more atomic layers that are formed, through epitaxial growth, on a given face of the graphene film 10. Preferably, the crystal lattice that constitutes the sheet of atoms or molecules 2 in the intercalation film 12 has in-plane three-fold symmetry or six-fold symmetry. Such an intercalation film 12 is formed, for instance, through epitaxial growth on a face of the formed graphene film 10. Materials appropriate as the intercalation film 12 in the present embodiment include an insulator material and a metallic material. Appropriate materials as the insulator material that is used in the intercalation film 12 include h-BN (hexagonal boron nitride), a MgO(111) plane, an Al₂O₃(0001) plane (sapphire) and a SiC(0001) plane. The plane indicator of the plane at growth takes place are explicitly indicated as the case may require. Likewise, appropriate metallic materials as the intercalation film 11 include a Fe(111) plane, a Co(0001) plane, a Ni(111) plane, a Cu(111) plane, a Ru(0001) plane, an Ir(111) plane, a Pd(111) plane and a Pt(111) plane. One or more materials can be selected in the intercalation film 12, both in the case of an insulator material and a metallic material.

For instance, the intercalation film 12 is sandwiched by the first graphene film 10A and the second graphene film 10B from among the graphene films 10 that comprise sheets of carbon atoms of one or more atomic layers in the conductive thin films 1000 and 1100 of the present embodiment. Therefore, interactions between π-electrons of the carbon atoms that make up two atomic layers disposed so as to sandwich the intercalation film 12 become weaker, from among the sheets of carbon atoms in the graphene film 10. As a result, electron mobility in the two sheets of carbon atoms is kept at a large value, such as the one in the case of monolayer graphene. If the intercalation film 12 is an insulator, the effect of weakening the interactions between π-electrons across sheets of carbon atoms, on both sides, that sandwich the intercalation film 12, is particularly substantial. As a result, it becomes possible to adequately prevent drops in mobility in the graphene films 10.

In a case where the intercalation film 12 is a metal, on the other hand, interactions may arise between the electron orbitals (d electrons or f electrons) of the metallic material and the π-electrons of the carbon atoms. However, such interactions do not bring about a significant drop in mobility, such as the one that occurs when two atomic layers of carbon atoms are adjacent to each other and a hybrid orbital forms accordingly between the π-electrons. If the intercalation film 12 is a metal, a different effect is elicited, in some instances, in that the conduction carriers from the region of the metallic intercalation film 12 are supplied, and there increases not the mobility but the carrier density, so that the sheet resistance of the conductive thin films 1000 and 1100 as a whole drops as a result.

Herein as well, the epitaxial growth method of the intercalation film 12 resorted to in the present embodiment is CVD or PVD. In a case where, for instance, CVD is resorted to in order to form a h-BN film, as the intercalation film 12, borazine gas, in which boron and nitrogen form a six-membered ring structure, is blown onto a face of a graphene film. The substrate 50 is for instance heated from the back, and hence the faces of the graphene film are likewise at high temperature. As a result of this process, an h-BN film derived from the cracked borazine gas is epitaxially grown while a state of matching with the crystal lattice of the sheets of carbon atoms is preserved. When using MBE as one PVD method, for instance a molecular beam of radicals having B and N as main components is supplied towards the face of the substrate 50 on which the graphene film 10 is formed, during formation of an h-BN film as the intercalation film 12. When resorting to PLD, as another PVD method, a molecular beam of h-BN is supplied to the face of the substrate 50 that corresponds to the graphene film 10, using h-BN as the target of the laser.

In the conductive thin films 1000 and 1100 of the present embodiment, the number of atomic layers included per intercalation film 12 ranges preferably from one to ten, particularly preferably from one to three. If the number of atomic layers included in the intercalation film 12 is eleven or more, the properties of the graphene film 10 become difficult to be reflected in the conductive thin film 1000 or 1100 as a whole. That is because the properties of the intercalation film 12 are dominant over those of the graphene film 10. The reason why a particularly preferred number of atomic layers included in the intercalation film 12 ranges from one to three is that, in that case, the sheets of carbon atoms included in the stacking unit 22A and the stacking unit 22B become integrated together and contribute thereby to electrical conductivity. This stems from the fact that good electrical conduction is maintained between the sheets of carbon atoms that sandwich the intercalation film 12 from both sides. In particular, conductivity in the conductive thin film 1000 or 1100 is good in a case where the ratio of the number of atomic layers in the sheets of carbon atoms and the number of atomic layers of the intercalation film 12 in the stacking unit 22A or 22B of the conductive thin film 1100 is about 1:3. That is because conduction in the thickness direction, i.e. a direction from one of the sheets of carbon atoms that sandwich the intercalation film 12 from both sides towards the other sheet of carbon atoms is secured, for instance, by virtue of the tunnel effect, while good in-plane two-dimensional electrical conductivity is preserved in the sheets of carbon atoms.

In the conductive thin film 1100 of FIG. 2(a), the stacking unit 22 is formed, for instance, in a number of units according to the performance required of the conductive thin film. The number of stacking units 22 that are stacked in the conductive thin film 1100 of the present embodiment is set so as to achieve a desired sheet resistance, in a case where the conductive thin film 1100 is used in applications where a low sheet resistance is required, for instance in wiring or the like By contrast, in a case where the conductive thin film 1100 formed according to the present embodiment is used as a transparent conductive film, the stacking units 22 are preferably formed in a such a number as to achieve a required optical transmittance, for instance a transmittance of 80% or higher, in order to combine thus both electrical conductivity and optical transparency.

Like the number of atomic layers of sheets of carbon atoms 1 that make up the graphene film 10, the number of atomic layers in the sheets of atoms or molecules included in the intercalation film 12 of the conductive thin films 1000 and 1100 of the present embodiment is not necessarily limited to only one atomic layer. The intercalation film 12 can be set to be a sheet of insulator atoms or metal atoms in which two or more atomic layers are directly stacked on each other. FIG. 2(b) illustrates an example of such a configuration.

FIG. 2(b) is a cross-sectional schematic diagram of a configuration example (conductive thin film 1200) of a conductive thin film in the present embodiment. The conductive thin film 1200 comprises a superlattice structure 120. The superlattice structure 120 has a stack of plurality of stacking units 24 each including the graphene film 10 and the intercalation film 12. The graphene film 10 comprises a sheet of carbon atoms 1 comprising one atomic layer, whereas the intercalation film 12 comprises a sheet of atoms or molecules 2 comprising a plurality of atomic layers. The substrate has been omitted in FIG. 2(b).

In the conductive thin film 1200, a sheet of atoms or molecules 2 comprising one atomic layer or three atomic layers is disposed in the intercalation film 12 included in one stacking unit 24. That is, the stacking units 24A and 24B comprise, respectively, graphene films 10A and 10B each formed of a sheet of carbon atoms 1 of one atomic layer, and the intercalation films 12A and 12B each formed of a sheet of atoms or molecules 2 of three atomic layers. The material that is used as the intercalation film 12 is typically an insulator or a metal. Therefore, the atoms or molecules 2 may be identical atoms or molecules within one sheet, or may be combinations of identical or dissimilar atoms across a plurality of sheets within each stacking unit 24, and across the stacking units 24A and 24B.

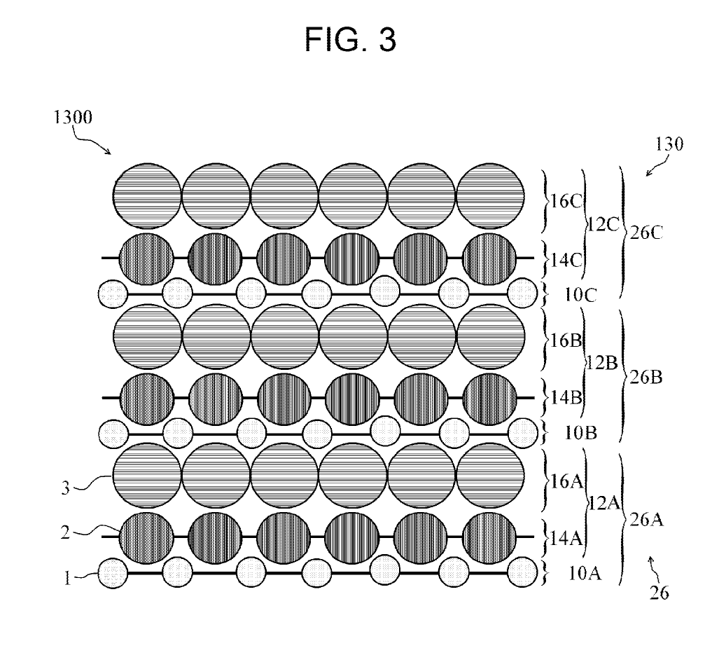

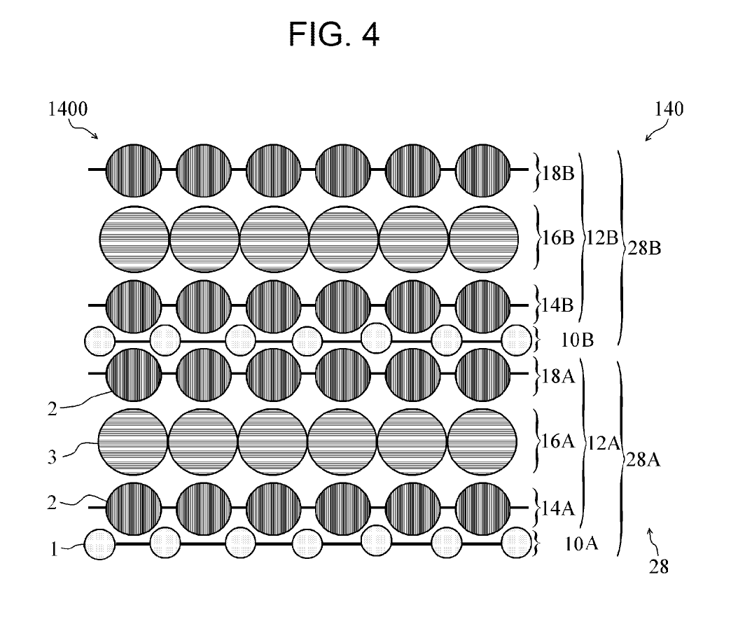

It should be noted that the various sheets need not necessarily be of the same material in a case where the intercalation film 12 comprises a plurality of sheets of atoms or molecules 2. A more preferred configuration focusing on this feature will he explained based on FIG. 3 and FIG. 4.

FIG. 3 is a cross-sectional schematic diagram illustrating a configuration example (conductive thin film 1300) of another conductive thin film of the present embodiment. The conductive thin film 1300 has a superlattice structure 130. The superlattice structure 130 is made up of a plurality of stacking units 26. The substrate has been omitted in FIG. 3.

Each stacking unit 26 in the conductive thin film 1300 comprises the graphene film 10 and the intercalation film 12, in this order from the side of the substrate (not shown). Each intercalation layer 12 is formed by a first unit intercalation film 14 and a second unit intercalation film 16 in this order, from the side of the substrate (not shown). FIG. 3 illustrates a configuration wherein the number of atomic layers in the graphene film 10, the first unit intercalation film 14 and the second unit intercalation film 16 is one atomic layer, in all cases. The first unit intercalation film 14 and the second unit intercalation film 16 in the conductive thin film 1300 are of mutually different materials. In FIG. 3, the superlattice structure 130 is formed substantially out of a stacking unit 26A, a stacking unit 26B and a stacking unit 26C. The number of stacking units 26 included in the superlattice structure 130 of the conductive thin film 1300 is not particularly limited. No particular limitation is imposed on the use of the conductive thin film 1300, whether the latter is used together with the substrate, or stripped off the latter.

The stacking units 26 in the conductive thin film 1300 of the present embodiment are typically made up of the first unit intercalation film 14 of an insulator and the second unit intercalation film 16 of a metallic material. In such a configuration, the first unit intercalation film 14A and the second unit intercalation film 16A elicit the effect of reducing interactions between the electrons included in the graphene films 10 that sandwich the first unit intercalation film 14 on both sides, for instance the graphene film 10A belonging to the stacking unit 26A and the graphene film 10B belonging to the stacking unit 26B. As a result, it becomes possible to preserve a high mobility value in the individual graphene films 10A, 10B and 10C even if multiple graphene films 10 are present in the superlattice structure 130. Moreover, the metallic material of the second unit intercalation film 16 has the action of supplying conduction carriers to the graphene films 10. For instance, electrons are supplied, from the second unit intercalation film 16A belonging to the stacking unit 26A, to the graphene film 10A belonging to the stacking unit 26A, and to the graphene film 10B belonging to the stacking unit 26B and that is adjacent to the second unit intercalation film 16A.

The action of supplying conduction carriers is brought about as a result of differences in the work functions for the metal atoms in the second unit intercalation film 16 and the electrons in the sheets of carbon atoms of the graphene film 10. In a case where work function of the metal atoms of the second unit intercalation film 16 is shallower than that of the graphene film 10, i.e., in the case of a negative value of an absolute value smaller than the vacuum level, which is taken as a reference, the electrons from the metal in the second unit intercalation film 16 are supplied to the graphene film 10, whereas holes (positive holes) are supplied in the opposite case. By virtue of such a mechanism, the density of conduction carriers in the graphene film 10 is increased, and hence it becomes possible to achieve high conductivity in the conductive thin film 1300 illustrated in FIG. 3, along with preservation of high mobility in the graphene film 10 elicited by the first intercalation film 12. Accordingly, the same effect can be afforded, in another typical example, by exchanging the positions of the metallic material and the insulator material, also when using a metallic material in the first unit intercalation film 14. Therefore, a configuration wherein the second unit intercalation film 16 is an insulator material is likewise an appropriate configuration of the present embodiment.

The number of stacking units 26 that make up the superlattice structure 130 of the conductive thin film 1300 is preferably set to a number such that a desired sheet resistance is obtained in a case where the conductive thin film 1300 is used for electrodes such as wiring or the like. The graphene film 10, the first unit intercalation film 14 and the second unit intercalation film 16 can all be made up of number of atomic layers that exceeds one atomic layer. In a case where the conductive thin film 1300 is used as a transparent conductive film, the stacking units 26 are preferably formed in such a number as to achieve a required optical transmittance, for instance a transmittance of 80% or higher.

FIG. 4 is a cross-sectional schematic diagram illustrating a configuration example (conductive thin film 1400) of yet another conductive thin film of the present embodiment. The substrate is also omitted in this figure. As illustrated in FIG. 4, a superlattice structure 140 of the conductive thin film 1400 is a stack of a plurality of stacking units 28. Each stacking unit 28 comprises the graphene film 10 and the intercalation film 12, in this order from the side of the substrate (not shown). The first unit intercalation film 14, the second unit intercalation film 16 and a third unit intercalation film 18 are sequentially formed in the intercalation film 12. Typically, the first unit intercalation film 14 and the third unit intercalation film 18 are both insulator materials, and the second unit intercalation film 16 is a metallic material.

In the superlattice structure 140 of the conductive thin film 1400 of the present embodiment there are fewer interactions between electrons across the graphene films 10, on both sides, disposed so as to sandwich all of the first unit intercalation film 14, the second unit intercalation film 16 and the third unit intercalation film 18. For instance, electron interactions between the atomic layers in the sheets of carbon atoms 1 belonging to the graphene films 10A and 10B, in the stacking units 28A and 28B, are reduced by the first unit intercalation film 14A, the second unit intercalation film 16A and the third unit intercalation film 18A in the stacking unit 28A. As a result, it becomes possible to preserve a high mobility value in the individual graphene films 10, even if multiple graphene films 10 are arranged in the conductive thin film 1400. Moreover, as in the case of the above-described superlattice structure 130 of the conductive thin film 1300 (FIG. 3), the metallic material in the second unit intercalation film 16 of the conductive thin film 1400 has the action of supplying conduction carriers to the graphene film 10. In addition, the metal atoms in the second unit intercalation film 16 are not in direct contact with the sheet of carbon atoms 1 belonging to the graphene film 10. For instance, conduction carriers from metal atoms of the second unit intercalation films 16A and 16B belonging to the stacking units 28A and 28B, respectively, are supplied to the graphene film 10B. By virtue of the presence of the third unit intercalation film 18A of the stacking unit 28A and the first unit intercalation film 14B of the stacking unit 28B, the sheet of carbon atoms 1 belonging to the graphene film 10B is not in direct contact with a metallic material. In the superlattice structure 140 of the conductive thin film 1400, the metallic material does not give rise to carrier scattering in the graphene film 10, since the metallic material is spaced apart from the graphene film 10.

Scattering of conduction carriers by the metal atoms that are adjacent to the sheet of carbon atoms 1 in the graphene film 10 occurs in instances where the metal atoms are in contact with a sheet of carbon atoms 1 and, moreover, the crystal lattice of the metal atom metal atoms is upset. When the crystal lattice of the metal atoms is upset and, for instance, the metal atoms become positioned randomly, these metal atoms elicit non-periodic potential fluctuations, on account of charge impurity, in the electrons of the two-dimensional electron gas of the graphene film 10. The electrons or holes in the graphene film 10 are scattered as a result, and mobility drops. In FIG. 4, the same notation has been used for the atoms or molecules 2 of the first unit intercalation film 14 and the third unit intercalation film 18. However, the same effect is achieved even if the atoms or molecules for the first unit intercalation film 14 and the atoms or molecules for the third unit intercalation film 18 are set to be mutually dissimilar insulators. Therefore, the present embodiment encompasses also a conductive thin film wherein disparate insulators are used in the atoms or molecules that are included in the first unit intercalation film 14 and the third unit intercalation film 18.

In the conductive thin film 1400 of FIG. 4, the number of stacking units 28 for forming the superlattice structure 140 is preferably set to a number such that a desired sheet resistance is obtained in a case where the conductive thin film 1400 is used for electrodes such as wiring or the like. The graphene film 10, the first unit intercalation film 14, the second unit intercalation film 16 and the third unit intercalation film 18 can be configured such that the number of atomic layers in one or more films of the foregoing exceeds one atomic layer. In a case where the conductive thin film 1400 is used as a transparent conductive film, the stacking units 28 in the superlattice structure 140 are preferably formed in a such a number as to achieve a required optical transmittance, for instance a transmittance of 80% or higher.

The superlattice structures 110 to 140 in the conductive thin films 1100 to 1400 illustrated in FIGS. 2 to 4 have all the minimal superlattice structure configuration of the conductive thin film of the present embodiment, illustrated as the superlattice structure 100 in FIG. 1. That is because the graphene films 10 included in selected adjacent stacking units from among the stacking units 22 to 28 in the superlattice structures 110 to 140 can be specified as the first and second graphene films.

### EXAMPLES

Examples 1 to 4, in which there are produced conductive thin films explained as a first embodiment of the present invention, are described next. Comparative examples not included in the first embodiment will be also explained, as the case may require, while referring to the reference symbols in the drawings. The materials, usage amounts, proportions, process features, process procedures and so forth can be modified as appropriate, without departing from the scope of the present invention. Therefore, the scope of the present invention is not limited to the below-described specific examples.

### Example 1 and Comparative Example 1

In Example 1 of the conductive thin film of the present embodiment there are produced samples having a conductive thin film having a configuration similar to that of the conductive thin films 1000, 1100 and 1200 illustrated in FIG. 1 and FIG. 2, and the electrical properties of the samples are measured. In the conductive thin film used in Example 1 a sheet of carbon atoms of just one atomic layer was disposed in each graphene film 10, as in the conductive thin films 1000, 1100 and 1200. The electrical properties were measured modifying the number of atomic layers included in the intercalation film 12 to zero, one to four, seven and ten atomic layers. In Example 1, specifically, samples of conductive thin films having dissimilar number of atomic layers included in the intercalation film 12 were also assessed, as seen from the conductive thin films 1000, 1100 and 1200 explicitly illustrated in FIGS. 1 to 3. A sample where the number of atomic layers included in the intercalation film 12 is zero is equivalent to a sample where the intercalation film 12 itself is not arranged, and is not encompassed by the present embodiment. Such a sample will be referred to hereafter as Comparative Example 1.

Herein, PLD was resorted to as the formation method for producing the samples of conductive thin films of Example 1 and Comparative Example 1, both for the graphene film 10 and the intercalation film 12. The reason for resorting to PLD in the formation process was that such a method affords high-precision control of the film thickness of units, in the form of atomic layers, during formation of the films. The substrate used in Example 1 was an atomically flat single-crystal Ni(111) plane substrate (hereafter “Ni substrate”). The Ni substrate was a 10 cm square Ni substrate cut out in such a way so as to expose the (111) plane. The (111) plane was prepared in such a manner so as to yield a clean surface intended as a foundation for epitaxial growth. Specifically, impurities included in the substrate were caused to precipitate, and a process was performed to remove the impurities, while the substrate was observed under RHEED (reflection high-energy electron diffraction). The precipitation process was performed by heating the substrate to a substrate temperature (set temperature) of 1000° C. within a chamber evacuated to ultra-high vacuum of about 1×10⁻⁹ Torr (1.33×10⁻⁷ Pa). The process of removing the precipitated impurities was performed by subjecting the substrate to flash annealing under conditions of substrate temperature 1500° C. and heating time of one second, in the same chamber. The outermost layer of the Ni substrate vaporizes instantly upon flash annealing, so that impurities having precipitated by that point in time are removed as a result. The processes of heating at 1000° C. and flash annealing were repeated until the RHEED spots became intense, to prepare thereby a clean surface of an atomically flat Ni(111) plane on the Ni substrate.

Next, carbon was supplied to the clean surface of the Ni substrate, to form thereby, by PLD, a graphene film 10 formed of a sheet of carbon atoms. In order to form the graphene film 10, graphite, as a laser target, was disposed opposing the clean surface of the Ni substrate, in a vacuum chamber. Then, a KrF excimer laser of wavelength 248 nm was irradiated, from outside the vacuum chamber, towards the target, at a power density the conditions of which had been determined beforehand. The Ni substrate was kept at 700° C. Carbon vaporized instantly by ablation was supplied, in the form of a molecular beam, out of the outermost surface of the graphite struck by the laser, towards the Ni substrate. During this operation, the surface of the Ni substrate was continuously observed by RHEED, and the RHEED spot intensities were monitored. The RHEED spot intensity varied when carbon supply was initiated, and hence the supply of carbon was discontinued, by shutting the laser off, when the RHEED intensity reached initially a maximum value, to control coverage of carbon thereby. The RHEED spot intensity denotes herein so-called RHEED oscillations. The RHEED spot intensity becomes greatest (maximum) when the coverage of the formed carbon corresponds to 0 ML (ML: monolayer), 1 ML, 2 ML, . . . , and is smallest (minimum) where the coverages corresponds to 0.5 ML, 1.5 ML, 2.5 ML, . . . . Accordingly, the above-described timing at which spot intensity exhibits initially a maximum value was the timing at which a sheet of carbon atoms of exactly one atomic layer covered the growth surface of the Ni substrate.

Next, the target onto which the laser was irradiated was changed to h-BN, and the same KrF excimer laser as described above was irradiated onto the target, to supply thereby a molecular beam of h-BN towards the graphene film on the Ni substrate. As was the case during growth of the graphene film, h-BN that constituted the intercalation film on the surface of the graphene film was epitaxially grown by PLD while under observation of RHEED spot intensity. The conditions of the power density of the excimer laser that were used herein were established beforehand so as to be appropriate for the formation of the intercalation film. The ratio between boron atoms and nitrogen atoms was set to a stoichiometric 1:1 ratio in the h-BN target. As found in earlier studies, however, the ratio of nitrogen atoms dropped in the h-BN film formed by ablation using the KrF excimer laser. Accordingly, the lower nitrogen fraction was compensated by supplying nitrogen radicals or ammonia, as the atmosphere during growth by PLD in the production of the sample of Example 1.

In order to produce samples of dissimilar number of atomic layers in the intercalation film in the present example, there were produced samples of Example 1 wherein the number of atomic layers of h-BN in the intercalation film (hereafter, “number of h-BN atomic layers”) was one to four, seven and ten, in accordance with the number of times, during monitoring of changes in RHEED oscillations, that the maximum value thereof was crossed.

The formation process of one stacking unit was completed by performing only once the above graphene formation process and the h-BN formation process. In the present example there were produced samples of a conductive thin film having a superlattice structure of eight stacking units, by repeating this formation process eight times. In Example 1, the conductive thin films 1000, 1100 and 1200 are identical expect for the fact that not all the stacking units in the structure of the produced conductive thin films are described, and that samples are produced where the number of atomic layers of the intercalation film was one to four, seven and ten.

For comparison purposes, a sample of Comparative Example 1 was also produced that included no intercalation film. In this sample, eight stacking units, each of which included only a graphene film formed of a sheet of carbon atoms of one atomic layer, were stacked on the Ni substrate,

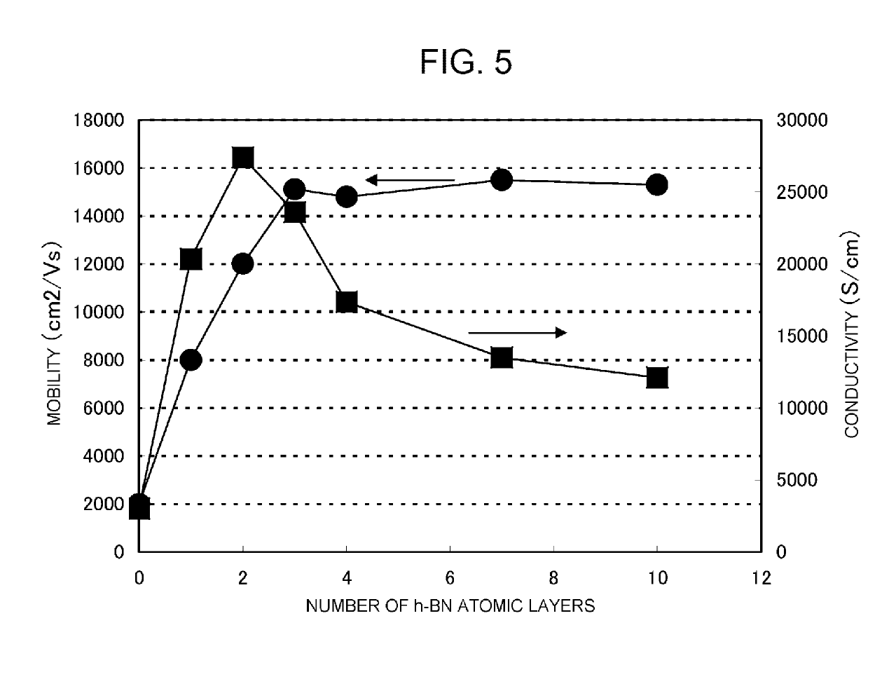

FIG. 5 illustrates a graph of measurement results of electric measurements for the samples of the produced conductive thin films in Example 1 of the present embodiment. The graph depicts the mobility (left ordinate axis, circles) in the sheets of carbon atoms included in the graphene films 10 of the conductive thin film, and the electrical conductivity (right ordinate axis, squares), assuming the entire conductive thin film to be a homogeneous thin film. The abscissa axis in the graph represents the number of atomic layers of h-BN that are disposed, as the intercalation film 12, between the graphene films 10, i.e. the number of h-BN atomic layers per stacking unit. The sample of Comparative Example 1, where the number of atomic layers of the produced h-BN was zero, is also depicted in the same graph.

The measurement method of the numerical values illustrated in FIG. 5 is as follows. The conductivity is calculated using the film thickness of the conductive thin film and the value of sheet resistance of the conductive thin film as measured after transfer onto a SiO₂ film that is formed on a Si substrate. Accordingly, the conductivity is a value based on the assumption that the conductive thin film is a homogeneous thin film. The mobility, by contrast, was calculated by performing a conversion such that the mobilities of respective sheets of carbon atoms were calculated, upon calculation of the mobility likewise on the basis of the measured sheet resistance. In specific terms, firstly the conductivity of only the sheets of carbon atoms was calculated from the sheet resistance measured using a substantial thickness taken up only by the sheets of carbon atoms. This substantial thickness was established as that of eight atomic layers, included in a conductive thin film, each layer having a thickness equivalent to the interlayer distance of graphite (0.335 nm). The conductivity of the sheets of carbon atoms alone was divided by the carrier density and elementary charge of the sheets of carbon atoms, to work out the mobility of each sheet of carbon atoms. The π-electron density, i.e. the number of carbon atoms per unit volume, was used the carrier density of the sheets of carbon atoms. In an actual substance, the carrier density is not necessarily limited to a constant that does not change with respect to the number of atomic layers of h-BN, but was assumed herein to be a constant numerical value,

As illustrated in FIG. 5, the mobility of the sheets of carbon atoms was significantly enhanced in the samples of Example 1, i.e. where the number of h-BN atomic layers was one or more, with respect to Comparative Example 1, where the number of atomic layers of h-BN was zero. This increase in mobility was observed up to a number of h-BN atomic layers of three. The mobility remained at a large value, but did not increase for a number of h-BN atomic layers of four or more. The small mobility in a case where, including also Comparative Example 1, the number of atomic layers (number of h-BN atomic layers) of the intercalation film ranges from zero to two, agrees with the understanding of the inventors to the effect that the band structure of the sheets of carbon atoms becomes that of a metalloid as a result of interactions between π-electrons in the sheets of carbon atoms.

The mobility can be brought to about 15000 cm²/Vs by prescribing the number of atomic layers in the intercalation film 12 to be three or more. The sheets of carbon atoms at a time where the number of atomic layers of the intercalation film 12 is set to be three or more exhibit large mobility, comparable to that of a case of one atomic layer (monolayer graphene) in a sheet of carbon atoms produced through mechanical stripping off a single crystal. This large mobility agrees also with the understanding to the effect that π-electron interactions between electrons in the stacked sheets of carbon atoms are weakened by the intercalation film, and a value close to the mobility of monolayer graphene is likely to be achieved.

By contrast, conductivity starts dropping when the number of atomic layers of the intercalation film is three or more. One reason for this is that the thickness of the conductive thin film as a whole varies in accordance with the number of atomic layers of the intercalation film, without any change in the total number of sheets of carbon atoms that contribute to conduction. A further reason, as anticipated by the inventors, is also involved herein. Specifically, conduction is limited to the two-dimensional plane of sheets of carbon atoms. When the number of atomic layers of the intercalation film 12 is large, carriers that move across sheets of carbon atoms, in the thickness direction of the conductive thin film, must traverse numerous atomic layers. Therefore, electrical conductivity in the thickness direction becomes harder. In contrast, it is found that electrical conduction is good between sheets of carbon atoms that sandwich an intercalation film, from both sides, in a case where the intercalation film has one to three atomic layers. For the reasons above, the inventors predict that configurations where the number of atomic layers of the intercalation film ranges from about one to three atomic layers should translate into conductive thin films that exhibit high conductivity.

High conductivity values in Example 1 correspond to instances where the sheets of carbon atoms per stacking unit have one atomic layer and the sheets of atoms or molecules in the intercalation film have three atomic layers. In Example 1 good conduction characteristics were achieved in those cases where atomic layers of the intercalation film were prescribed to satisfy the above ratios.

The effect brought about by intercalating atomic layers of an insulator material and the effect of varying the number of atomic layers of the insulator material in the conductive thin film of the present embodiment were checked using the samples, produced in Example 1, having a dissimilar number of atomic layers in the intercalation film of the insulator.

### Example 2

In Example 2 next there was produced a conductive thin film of a structure similar to that of the conductive thin film 1300 illustrated in FIG. 3. The conductive thin film of Example 2 was formed through stacking of eight of the stacking units 26 that make up the superlattice structure 130. In each stacking unit 26, the graphene film 10 included a sheet of carbon atoms of one atomic layer. The first unit intercalation film 14 included three h-BN atomic layers, and Ni was used as the second unit intercalation film 16. The number of atomic layers of Ni in the second unit intercalation film 16 was caused to vary to yield the various samples of Example 2.

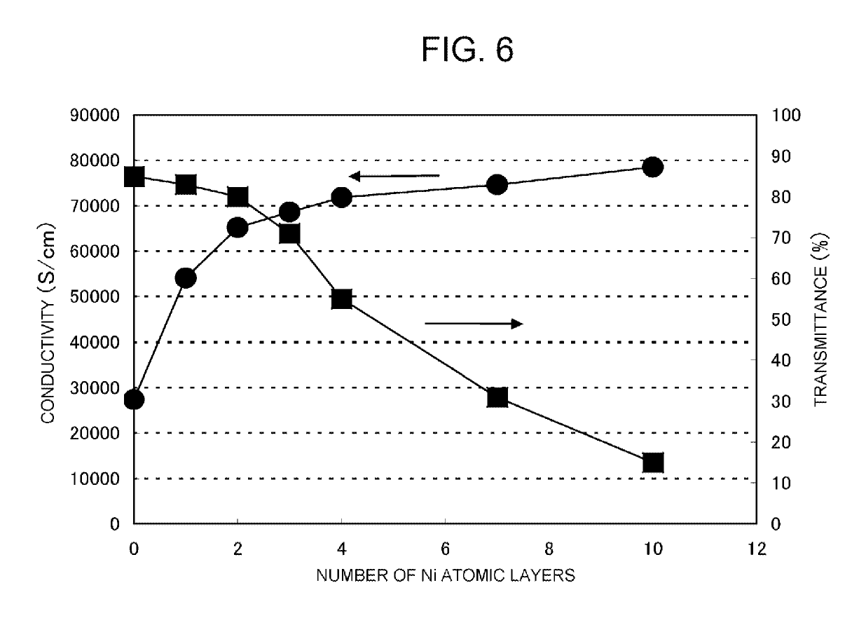

The graph in FIG. 6 depicts the conductivity (left ordinate axis, circles) and the optical transmittance (right ordinate axis, squares) assuming the entire conductive thin film to be a homogeneous thin film, for the samples of the conductive thin film produced in Example 2 of the present embodiment. For purposes of comparison there was produced also a conductive thin film having a configuration where no Ni was formed and no first unit intercalation film 14 was used. The abscissa axis of the graph represents the number of atomic layers of Ni.

As the conductivity in FIG. 6 shows, it was found that the conductivity of the conductive thin film is enhanced when Ni is formed over one or more atomic layers per stacking unit 26, as compared with instances where no Ni is formed. The conductivity increases as the number of atomic layers of Ni grows. The inventors speculate that the underlying cause for this resides on the effect elicited through the supply of conduction carriers to the sheets of carbon atoms of the graphene films, when the number of atomic layers of Ni is small, of about one to three atomic layers. Although conductivity increases as the number of atomic layers of Ni becomes higher, no further increases are observed when the number of atomic layers is about three or more. The reason for this may be attributed to the fact that a higher number of atomic layers of Ni translates into a greater relative ratio of the second unit intercalation film 16 in the conductive thin film as a whole, so that, as a result, the influence of Ni, as an ultra-thin film, becomes greater, and also to the influence derived from the fact that the above-described effect on carrier supply to the graphene film 10 is already fully brought out.

FIG. 6 illustrates the change in optical transmittance of the conductive thin film as a whole with respect to the number of atomic layers of Ni. Transmittance was measured within a wavelength range from 400 to 2000 nm, using a spectrophotometer, and the value measured at a wavelength of 550 nm was taken as the transmittance in question. Ordinarily, transmittance tends to drop when the number of atomic layers of Ni increases, since the ratio of metal in the conductive thin film increases accordingly in that case. This trend was observed also in the samples of Example 2. The value of transmittance was kept at a comparatively large value in a case where the number of atomic layers of Ni ranged from about one to three. The inventors speculated that the reason for this is that the intercalation film 12 itself starts exhibiting light transmission characteristics of an ordinary metal thin film when the number of atomic layers of Ni is substantial, whereas in the case of a number of atomic layers up to about four, carriers are provided to the sheets of carbon atoms, and the free-electron gas characteristics of the metal film itself are not readily manifested.

The effect of intercalating atomic layers of a metallic material in the second unit intercalation film, and the effect of modifying the number of atomic layers, in the conductive thin film of the present embodiment, were checked thus using the samples produced in Example 2.

### Example 3

In Example 3 next there was produced a conductive thin film of a structure similar to that of the conductive thin film 1400 illustrated in FIG. 4. In the conductive thin film of Example 3 as well there were stacked eight stacking units 28. The number of atomic layers in the sheet of carbon atoms in the graphene film 10 within each stacking unit 28 was set to one. The first unit intercalation film 14 and the third unit intercalation film 18 included each two atomic layers of h-BN. The second unit intercalation film 16 was produced by modifying the number of atomic layers for each sample. Ni was formed as the metallic material of the second unit intercalation film 16.

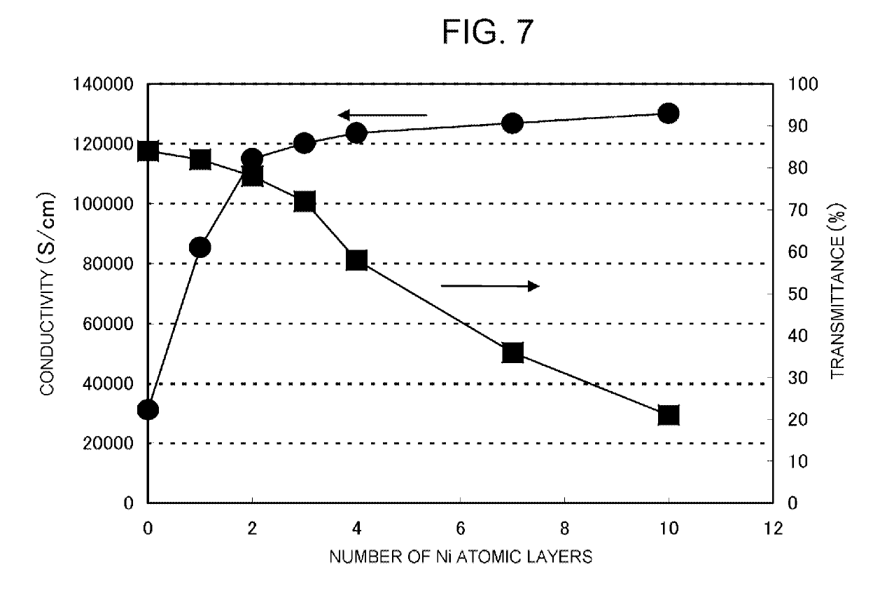

The graph in FIG. 7 depicts the conductivity (left ordinate axis, circles) and the optical transmittance (right ordinate axis, squares), assuming the entire conductive thin film to be a homogeneous thin film, for the samples of the conductive thin film produced in Example 3 of the present embodiment. For purposes of comparison there was produced also a conductive thin film having a configuration where no Ni was formed and no first unit intercalation film 14 was used.

A comparison between the results of the various samples of Example 3 illustrated in FIG. 7 versus those of Example 2 illustrated in FIG. 6 reveals the same trend whereby conductivity depends on number of atomic layers of Ni. As in Example 2, the conductivity in Example 3 increases as the number of layers of the Ni atomic layers becomes higher. A more detailed assessment of the differences with respect to Example 2 reveals that in Example 3, the value of conductivity increases, with respect to that in Example 2, when the number of atomic layers of Ni is one or more. The inventors attribute this to the influence of the sandwiching of sheets of carbon atoms between insulator h-BN. Specifically, it is deemed that the adverse influence that metal atoms, as charge impurities, exert on the sheets of carbon atoms. i.e. carrier scattering, is suppressed, since in the structure of Example 3 (FIG. 4) no metal atom layers are in direct contact with sheets of carbon atoms.

FIG. 7 illustrates the change in optical transmittance of the conductive thin film as a whole with respect to the number of atomic layers of Ni. The various samples of Example 3 exhibit the same trend in transmittance with respect to the number of atomic layers of Ni, and the same values of transmittance, as in Example 2.

The effect brought about in the conductive thin film o he present embodiment by the insulating material of the first and third unit intercalation films, i.e. the effect whereby the metallic material of the second unit intercalation layer does not come into direct contact with the graphene films, and the effect of modifying the number of atomic layers of the metallic material in the second unit intercalation layer, were checked using the samples produced in Example 3.

### Example 4

Conditions for utilizing the conductive thin film of the present embodiment as a transparent conductive film were assessed next. As observed in Example 2 and Example 3, optical transmittance could be maintained in the present embodiment by appropriately selecting a configuration of the intercalation film 12 that is to be formed, even if a metallic layer or an insulating layer is used as the intercalation film 12 (including the first to third unit intercalation films 14 to 18). Actually, high transmittance of about 80% was obtained in all cases where the second unit intercalation film 16 of the stacking units 26 and 28, in an eight-unit stack, included just two atomic layers of Ni, in the samples of Example 2 and Example 3. The graphene films 10 of the stacking units 26 and 28 comprise each a sheet of carbon atoms of one atomic layer, and hence the total number of sheets of carbon atoms in the conductive thin film amounted to eight atomic layers,

In the case of those samples, in Example 2, where the second unit intercalation film 16 (Ni) included two atomic layers, the total number of atomic layers included in the conductive thin film was 48 atomic layers. That is because each stacking unit 26 comprises a graphene film 10 of a sheet of carbon atoms of one atomic layer, the first unit intercalation film 14 of three atomic layers of h-BN, and the second unit intercalation film 16 of two atomic layers of Ni, and the stack comprises eight stacking units 26. As illustrated in the graph of FIG. 6, absorptance in this case is about 20%, as the difference between 100% and a transmittance of about 80%. Absorption by the eight atomic layers of sheets of carbon atoms amounts to about 17%. This indicates that the substantial transmittance of the conductive thin films produced in Example 2 is governed by the influence of the sheets of carbon atoms included in the conductive thin film. In a case where the conductive thin film of the present embodiment is used as a transparent conductive film, the influence exerted on absorption by the total number of atomic layers in the sheets of carbon atoms of the graphene film 10 included in the entire transparent conductive film is greater than the influence of the intercalation film 12. The absorptance by the sheets of carbon atoms is herein a value resulting from working out the absorptance of light that passes sequentially through the eight sheets of carbon atoms, on the basis of an absorptance of about 2.3% for monolayer graphene (sheet of carbon atoms of one atomic layer) disclosed in Non-Patent Document 4.

In Example 4, thus, samples for measuring transmittance were produced by adjusting the total number of sheets of carbon atoms. The results are summarized in Table 1. The total number of sheets of carbon atoms was adjusted by adjusting the number of stacking units. The structure of the conductive thin film 1300 (FIG. 3) was used herein as the structure of the conductive thin film, and one atomic layer of h-BN and two atomic layers of Ni were formed in the first unit intercalation film 14 and the second unit intercalation film 16, respectively, of the stacking unit 26.

TABLE 1

| | Number of atomic layers | |
|---|---|---|
| | (total) in sheets of carbon | |
| Number of stacking units | atoms | Transmittance (%) |
| 4 | 4 | 89 |
| 8 | 8 | 80 |
| 12 | 12 | 72 |

As Table 1 shows, the number of atomic layers in the sheets of carbon atoms included in the conductive thin film for securing about 80% transmittance was about eight. The number of atomic layers of the sheets of carbon atoms included in the conductive thin film in order to secure a transmittance of about 70% was about twelve.

In Example 4, the change in transmittance elicited through modification of the number of stacking units, and the fact that the main cause thereof is absorption by the sheets of carbon atoms, were checked in the conductive thin film of the present embodiment using the produced samples.

### Example 5

Based on the configuration of Example 4, there was assessed a preferred configuration in order to utilize the conductive thin film as a transparent conductive film, focusing on the total number of sheets of carbon atoms alone. As described above, an absorptance of 2.3% of a sheet of carbon atoms of one atomic layer (monolayer graphene) is found to be high enough to determine the transmittance of the conductive thin film as a whole. By contrast, light passes through, without being absorbed, if the material used as he intercalation film is for instance an insulating material. The transmittance per one atomic layer is higher than that in the case of the sheets of carbon atoms, even if the intercalation film is a metal. If there is established a criterion of transmittance for the use of the film as a transparent conductive film, therefore, it becomes possible to determine whether the conductive thin film of the present embodiment can be used or not as a transparent conductive film, on the basis of that criterion, by specifying the total number of atomic layers of sheets of carbon atoms.

In the present embodiment, preferably, the total number of sheets of carbon atoms is ten atomic layers or fewer. The value of ten atomic layers is a calculated value for an instance where each sheet of carbon atoms exhibits absorption of 2.3%, with a reference value of transmittance set to 80%. Specifically, the numerical value of ten layers was obtained by working out the upper limit of number of sheets such that the transmittance criterion can be reached, on the basis of the fact that light is attenuated to 97.7% each time the light traverses a sheet of carbon atoms. The number of atomic layers of the sheets of carbon atoms could thus be determined in accordance with the reference value of transmittance.

By adopting the configuration of he conductive thin film 1100 or 1200 of FIG. 2(a) and using, for instance, an insulating material as the intercalation film 12, it becomes possible to bring the mobility in each sheet of carbon atoms close to the value of monolayer graphene, even if the sheets of carbon atoms are ten atomic layers or fewer. Also, conductivity can be increased to a sufficient value, even when using sheets of carbon atoms of ten or fewer atomic layers, by adopting the configuration of the conductive thin film 1300 of FIG. 3 or the conductive thin film 1400 of FIG. 4, using an insulating material in the first unit intercalation film 14 and the third unit intercalation film 18, and using a metallic material in the second unit intercalation film 16.

In Example 4, the same transmittance reference value of 80% was obtained across the eight atomic layers. That is because attenuation by the Ni film takes place simultaneously, and hence a similar transmittance is obtained under conditions of few sheets of carbon atoms.

### First Embodiment: Variation

The conductive thin films of the present embodiment can all be transferred to any substrate. This process will be explained on the basis of the conductive thin film 1100 (FIG. 2(a)). Firstly, as illustrated in FIG. 2(a), the conductive thin film 1100 is formed on a face of the substrate 50. Herein, the conductive thin film 1100 is produced by carrying out the formation process of the stacking units for the required number of stacking units, so as to satisfy the required electric characteristics optical characteristics depending on the intended application. Next, a support plate (not shown) is bonded from above the paper surface in FIG. 2(b). For instance, a substrate of a soluble resin that can be dissolved later on is used herein as the support plate. Next, with the support plate still bonded, the substrate 50 is removed through etching. If the substrate 50 is for instance a metallic material such as Ni, the substrate 50 is removed in accordance with a method such as immersion in an acidic etchant. The conductive thin film 1100 becomes thus transferred to the bonding surface of the support plate. Thereafter, the conductive thin film 1100 transferred to the support plate is in turn transferred to a final substrate for supporting the conductive thin film 1100. To this end, the face of the support plate onto which the conductive thin film 1100 is bonded is pressed onto the face of the final substrate, and the support plate is dissolved thereafter. No heating treatment at high temperature is required if the above process is resorted to, and hence it becomes possible to form the conductive thin film 1100 even in cases where a low-melting-point plastic substrate or the like is used as the final substrate.

Embodiments of the present invention have been explained in detail above. The purpose of the embodiments and examples described above is to explain the invention, but the scope of the invention of the present application is defined on the basis of the disclosure of the appended claims. Variations within the scope of the present invention, including other combinations of the various embodiments, fall within the scope of the claims.

### INDUSTRIAL APPLICABILITY

The present invention makes a contribution to the spread of electronic devices that rely on conductive thin film or transparent electrodes that comprise graphene.

1. A conductive thin film, comprising:
a superlattice structure that includes:
a first graphene film formed of a sheet of carbon atoms having one or more atomic layers;
a second graphene film formed of a sheet of carbon atoms having one or more atomic layers; and
an intercalation film sandwiched between the first and second graphene films.

2. The conductive thin film according to claim 1, wherein the superlattice structure has a plurality of stacking units that are stacked and that are each formed of one graphene film and one intercalation film; and
wherein the first and second graphene films are graphene films belonging to two mutually adjacent stacking units from among the plurality of stacking units.

3. The conductive thin film according to claim 1, wherein the intercalation film is made of an insulator material.

4. The conductive thin film according to claim 1, wherein the intercalation film is made of a metallic material.

5. The conductive thin film according to claim 1, wherein the intercalation film comprises a first unit intercalation film and a second unit intercalation film having mutually dissimilar compositions; wherein a combination of the first unit intercalation film and the second unit intercalation film is one of (a) a combination of an insulator material and a metallic material, respectively, and (b) a combination of a metallic material and an insulator material, respectively; wherein the superlattice structure has a plurality of stacking units that are stacked and that are each formed of one graphene film, one first unit intercalation film and one second unit intercalation film; and wherein the first and second graphene films are graphene films belonging to two mutually adjacent stacking units from among the plurality of stacking units.

6. The conductive thin film according to claim 1, wherein the intercalation film comprises a first unit intercalation film made of an insulator material, a second unit intercalation film made of a metallic material, and a third unit intercalation film made of an insulator material; wherein the superlattice structure has a plurality of stacking units that are stacked and that are each formed of one graphene film, one first unit intercalation film, one second unit intercalation film, and one third intercalation film and wherein the first and second graphene films are graphene films belonging to two mutually adjacent stacking units from among the plurality of stacking units.

7. The conductive thin film according to claim 1, wherein the intercalation film has a plane and includes an atomic layer having a crystal lattice that has three-fold symmetry or six-fold symmetry in the plane of the intercalation film.

8. The conductive thin film according to claim 1, wherein the first and second graphene films are made of respective sheets of carbon atoms that each have from one to five atomic layers, respectively.

9. The conductive thin film according to claim 1, wherein the intercalation film is made of from one to ten atomic layers.

10. The conductive thin film according to claim 2, wherein, in each of the stacking units, the intercalation film is made of three atomic layers, and the first and second graphene films are made of respective sheets of carbon atoms that each have one atomic layer.

11. A transparent conductive film, comprising:
a superlattice structure that includes:
a first graphene film formed of a sheet of carbon atoms having one or more atomic layers;
a second graphene film formed of a sheet of carbon atoms having one or more atomic layers; and
an intercalation film sandwiched between the first and second graphene films.

12. The transparent conductive film according to claim 11, wherein the superlattice structure has a plurality of stacking units that are stacked and that are each formed of one graphene film and one intercalation film; wherein the first and second graphene films are graphene films belonging to two mutually adjacent stacking units from among the plurality of stacking units; and wherein the graphene films are made of respective sheets of carbon atoms that each have at least one atomic layer and a sum total of atomic layers of the sheets of carbon atoms for all the stacking units is ten or fewer.

13. The conductive thin film according to claim 2, wherein the intercalation film has a plane and includes an atomic layer having a crystal lattice that has three-fold symmetry or six-fold symmetry in the plane of the intercalation film.

14. The conductive thin film according to claim 3, wherein the intercalation film has a plane and includes an atomic layer having a crystal lattice that has three-fold symmetry or six-fold symmetry in the plane of the intercalation film.

15. The conductive thin film according to claim 4, wherein the intercalation film has a plane and includes an atomic layer having a crystal lattice that has three-fold symmetry or six-fold symmetry in the plane of the intercalation film.

16. The conductive thin film according to claim 5, wherein the intercalation film has a plane and includes an atomic layer having a crystal lattice that has three-fold symmetry or six-fold symmetry in the plane of the intercalation film.

17. The conductive thin film according to claim 6, wherein the intercalation film has a plane and includes an atomic layer having a crystal lattice that has three-fold symmetry or six-fold symmetry in the plane of the intercalation film.

18. The conductive thin film according to claim 1, wherein the conductive thin film is transparent.

19. The conductive thin film according to claim 2, wherein the conductive thin film is transparent; and wherein the graphene films are made of respective sheets of carbon atoms that each have at least one atomic layer and a sum total of atomic layers of the sheets of carbon atoms for all the stacking units is ten or fewer.
